(19) United States
(12) Patent Application Publication
(10) Pub. No.: US 2016/0189341 A1
(43) Pub. Date: Jun. 30, 2016

(54) SYSTEMS AND METHODS FOR MAGNIFYING THE APPEARANCE OF AN IMAGE ON A MOBILE DEVICE SCREEN USING EYEWEAR

(71) Applicant: SLING MEDIA PVT LTD, Bangalore (IN)

(72) Inventor: Vikram Balarajashetty, Karnataka (IN)

(21) Appl. No.: 14/584,053

(22) Filed: Dec. 29, 2014

(51) Int. Cl. G06T 3/40; H04N 13/02; H04N 13/04; G02B 27/01

(52) U.S. Cl. CPC G06T 3/40; G02B 27/0101; H04N 13/0239; H04N 13/0296; H04N 13/044; H04N 13/0484; G02B 2027/0178; G02B 2027/0138; G02B 2027/014

(57) ABSTRACT

A system for magnifying the appearance of an image on a mobile device screen includes an eyewear frame adapted to be mounted on a user in the user's field of vision, an image capturing device connected to the eyewear frame and oriented to capture an image in the user's field of vision, and an image display device connected to the eyewear frame and oriented to display the captured image to the user. The system further includes a processor in electronic connection with the image capturing device and the image display device. The processor is configured to analyze the captured image for the presence of the mobile device screen, and, if the mobile device screen is present, magnify the image to include a magnified mobile device screen image in the magnified captured image and send the magnified captured image to the image display device for display to the user.

### TECHNICAL FIELD

The present disclosure relates generally to systems and methods that assist a user in viewing mobile device screens. More particularly, the present disclosure relates to systems and methods for magnifying the appearance of an image on a mobile device screen using eyewear.

### BACKGROUND

Electronic devices are becoming more and more ubiquitous because they help users manage their busy schedules, as well as communicate with the world. For example, smartphones and other mobile devices (hereinafter referred to collectively as “mobile devices”) are becoming a necessity for many. A mobile device is a handheld device that allows users to access information, keep track of their busy schedules, and communicate with others. A typical mobile device can function as a mobile or cellular phone, internet-enabled device, and personal organizer Recently, many of the major announcements revolve around wireless connectivity for a mobile device. It is very important for today's mobile professional to able to access information from anywhere in the world.

Mobile devices are very popular because they are designed to be portable and small. Currently, mobile device manufactures strive to make mobile devices as potable and small as possible. Fitting easily into a wallet, small purse, or shirt pocket, the newest mobile devices can travel anywhere in the world. People do not think twice about taking them anywhere. The new micro-sized mobile devices come equipped with the features users value most, including a calendar, address book and Web access capabilities, weather forecast, and the latest news.

However, although there are many advantages to having a micro-sized mobile device, the new smaller mobile devices also have smaller screens, which can be difficult to read for many people. Mobile professionals are receiving an increasing amount of e-mails and information on their mobile devices. Large amount of information packed and cluttered onto a tiny screen can cause eyestrain and headaches. In addition, cluttered information represented on a small screen can be difficult to read, which can cause a user to overlook important information, such as appointments, messages, reports, etc.

As such, there is a continuing need in the art for systems and methods that allow mobile device users to better view their screens. The proliferation of electronically-enabled eyewear additionally makes it desirable for such systems and methods to be accessible using such eyewear. Moreover, other desirable features and characteristics of the present disclosure will become apparent from the subsequent detailed description the appended claims, taken in conjunction with the accompanying drawings and background.

### BRIEF SUMMARY

The various embodiments disclosed herein relate to systems and methods for magnifying the appearance of an image on a mobile device screen using eyewear. In one embodiment, a system includes an eyewear frame adapted to be mounted on a user in the user's field of vision, an image capturing device connected to the eyewear frame and oriented to capture an image in the user's field of vision, and an image display device connected to the eyewear frame and oriented to display the captured image to the user. The system further includes a processor in electronic connection with the image capturing device and the image display device. The processor is configured to analyze the captured image for the presence of the mobile device screen, and, if the mobile device screen is present, magnify the image to include a magnified mobile device screen image in the magnified captured image and send the magnified captured image to the image display device for display to the user.

In another exemplary embodiment, a method includes the steps of capturing an image, analyzing the image for the presence of a mobile device, and determining if a mobile device is present in the image based on the analyzing. The method further includes, if a mobile device is determined to be present in the image, the steps of magnifying the captured image to include at least a magnified mobile device screen image in the magnified captured image and displaying the magnified captured image.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE FIGURES

The disclosed embodiments will hereinafter be described in conjunction with the following drawing figures, wherein like numerals denote like elements, and wherein:

FIG. 1A is an illustration of exemplary eyewear in accordance with one embodiment of the present disclosure;

FIG. 1B is an illustration of an exemplary mobile device in accordance with one embodiment of the present disclosure that may appear in the field of view of the eyewear as depicted in FIG. 1A;

FIG. 2 is a block-and-flow diagram illustrating a method for analyzing an image captured by the eyewear in accordance with an exemplary embodiment;

FIG. 3 is an exemplary field of view of the eyewear including a mobile device; and

FIG. 4 is a block-and-flow diagram illustrating a method for magnifying the appearance of an image on a mobile device screen using eyewear in accordance with an embodiment.

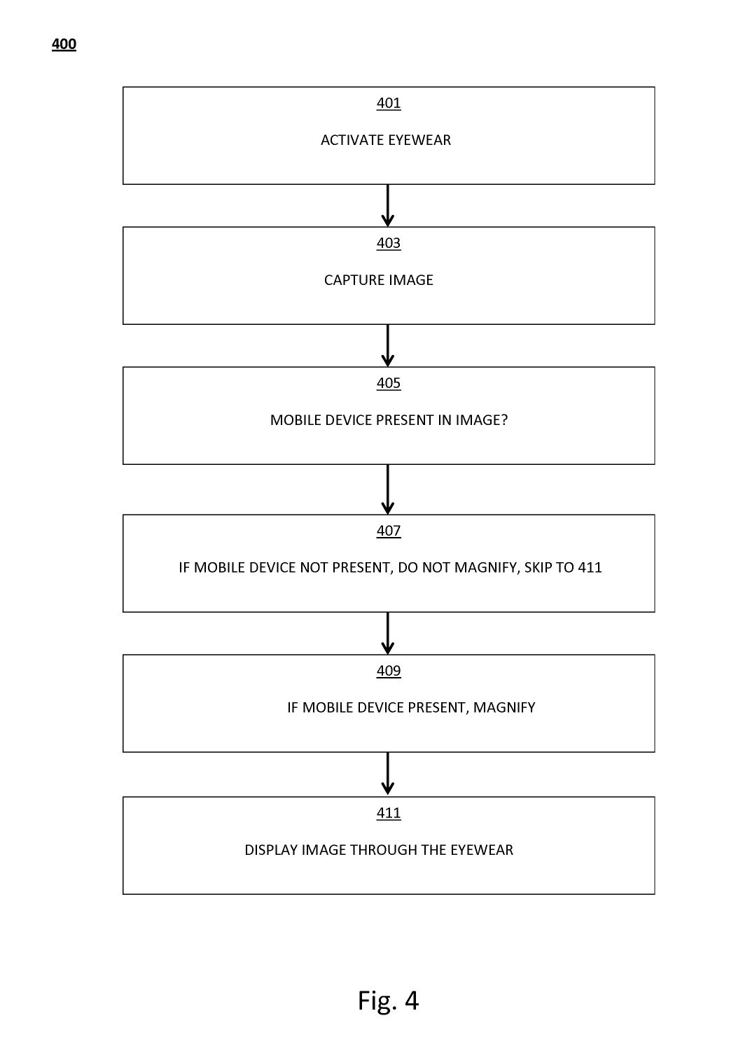

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Embodiments of the present disclosure are generally directed to systems and methods for magnifying the appearance of an image on a mobile device screen using eyewear. Exemplary eyewear may be embodied as a head-mounted display (HMD), which includes an image capturing device and an image display device, supported by a frame that is wearable in a user's field of vision (e.g., in the manner of eyeglasses). The image capture device captures and image in the user's field of view, and displays the image to the user using the image display device. A magnification function of eyewear is able to differentiate between captured images that include a mobile device screen and image that do not include a mobile device screen. For those captured images that do not include a mobile device screen, the magnification function of the eyewear causes the image display device of the eyewear to display the captured image to the user at standard magnification (i.e., unmagnified). For those captured images that do include a mobile device screen, the magnification function of the eyewear causes the image display device of the eyewear to display the captured image to the user at an enhanced magnification, for example 1.5× magnification, 2.0× magnification, or any other suitable magnification that is greater than the standard magnification. The magnified image includes at least the mobile device screen. In this manner, when the user views a mobile device screen, the image presented to the user through the eyewear is magnified, whereas the image is not magnified if the user is not looking at a mobile device screen, thus allowing the user to more easily see the images on the mobile device screen. In this regard, an exemplary method includes, using eyewear, capturing an image and detecting whether a mobile device screen is present in the capture image. If a mobile device screen is present, magnifying the image and displaying the magnified image. If a mobile device screen is not present, displaying the captured image at standard (i.e., unmagnified) magnification.

### Head-Mounted Display

Embodiments of the present disclosure employ the use of eyewear that may be provided in the form of a head-mounted display (HMD), which includes an image capturing device and an image display device, supported by a frame that is wearable in a user's field of vision (e.g., in the manner of eyeglasses). The image capture device captures and image in the user's field of view, and displays the image to the user using the image display device.

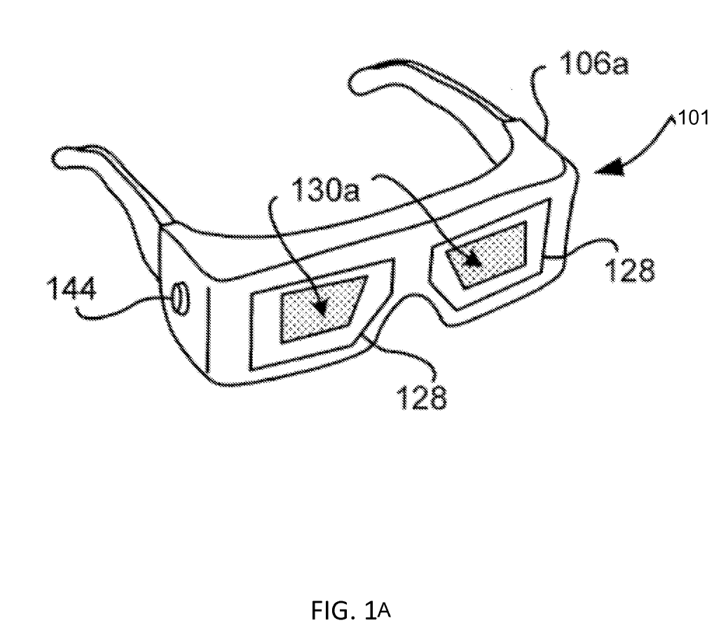

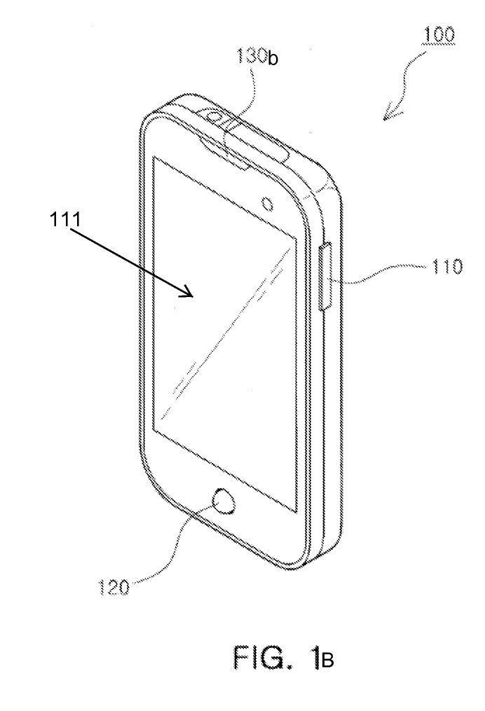

Referring to FIG. 1A, the eyewear 101 in one embodiment includes a pair of eyeglass frames 106a. In this embodiment, the traditional transparent lenses in the eyeglasses frames 106a have been replaced with one or two display screens 130a. Attached to the frame 106a are one or more image capture devices 128, such as a camera. The electronics provide for image capture by the image capture devices 128 and transmission to a processor 144 by way of a wired or wireless link. The processor 144 not only receives images from the image capture device 128, but transmits the images to the eyeglass frames 106a for display on one or both of the display screens 130a.

In various embodiments, the displays 130a in the eyeglass frames 106a include two Organic Light Emitting Diode (OLED) micro-displays for the left and right eyes. In another embodiment, the displays 130a use Liquid Crystal on Silicon (LCOS) technology. In a further embodiment, the displays 130a use Liquid Crystal Display (LCD) technology. In still a further embodiment, the displays 130a use micro-projection technology onto a reflective (partial or 100% reflective) glass lens. In various embodiments, each display shows a different image or the same image. If the image is to be displayed only to one eye, only one display 130a is required. The displays 130a in various embodiments can incorporate refractive lenses similar to traditional eyeglasses.

The image capture device 128 in one embodiment incorporates optical components for focusing the image, a motor for controlling the focus position, and a Complimentary Metal Oxide Semiconductor (CMOS) image sensor. In another embodiment, the image capture device 128 is a charge coupled device (CCD) sensor with appropriate optics. In other various embodiments, the image capture device 128 is any imaging device with an analog or digital signal output.

In a binocular configuration, each image capture device or camera 128 sees a slightly different image, thereby providing stereoscopic vision to the viewer. If the image is to be presented to only one eye, then only one image capture device or camera 128 is needed to record the image for that eye. Although in the embodiment shown the image capture device or camera 128 and related electronics are mounted on the eyeglass frames 106a, it is contemplated that the camera 128 and electronics could also be located elsewhere on the individual's person. Also, although two cameras 128 are contemplated for binocular vision, it is possible for one camera 128 to view the image and present the same image to both displays 130a.

An optional eye tracking camera may also be in communication with the processor 144 and determines where in the visual field the individual is looking In one embodiment, this camera operates by following the position of the pupil. Such eye tracking devices are common in presently-available “heads-up-displays” utilized by aircraft pilots. Again, although an embodiment contemplated includes two tracking cameras, because both eyes typically track together, one tracking device may be used. In another embodiment, the eye tracking sensor uses a combination of mirrors and prisms such that the optical path for the eye tracking sensor is orthogonal to the pupil. Eye tracking is used to determine the region of interest (ROI). The eye-tracking information is suitably averaged and dampened in software to minimize the sensitivity to random eye movements, blinks, etc., and to optimize the system for various usage models. For example, reading English requires specific eye tracking performance in the left to right direction different from that in the right to left direction, and different again from that in the vertical direction.

Images from the image capture device 128, optional eye position information from the eye tracking camera and images destined for the displays 130a are passed through the processor 144. This communication between the processor 144 and the electronics of the eyeglass frames 106a may be transmitted through a wired connection or be transmitted wirelessly. Certain functions, such as magnification as will be described in greater detail below, may be performed in an analog mariner, such as by adjusting the lens array on the camera 128 or digitally by mathematically processing pixels.

### Mobile Device Screen

As noted above, due to their small size, and due to the images and text presented thereon in a miniaturized manner, the eyewear of the present disclosure may be employed to magnifying images that originate from a mobile device screen. As used herein, the term mobile device refers to As used herein and throughout this disclosure, the term “mobile device” refers to any electronic device having a digital display screen, and typically the electronic device is also capable of communicating across a mobile network. A mobile device may have a processor, a memory, a transceiver, an input, and an output. Examples of such devices include cellular telephones, smart phones, tablet computers, personal digital assistants (PDAs), portable computers, etc. The memory stores applications, software, or logic. Examples of processors are computer processors (processing units), microprocessors, digital signal processors, controllers and microcontrollers, etc.

Mobile devices communicate with each other and with other elements via a network, for instance, a cellular network. A “network” can include broadband wide-area networks, local-area networks, and personal area networks. Communication across a network can be packet-based or use radio and frequency/amplitude modulations using appropriate analog-digital-analog converters and other elements. Examples of radio networks include GSM, CDMA, Wi-Fi and BLUETOOTH® networks, with communication being enabled by transceivers. A network typically includes a plurality of elements such as servers that host logic for performing tasks on the network. Servers may be placed at several logical points on the network. Servers may further be in communication with databases and can enable communication devices to access the contents of a database.

FIG. 1B is a perspective view illustrating the external appearance of a mobile device 100 according an embodiment of the present disclosure. The mobile device 100 includes a display unit 110 outputting a display screen 111, an input unit 120, and an audio output unit 130b. The input unit 120 may be implemented as a mechanical button as illustrated in FIG. 1B or may be a touch screen device that is integrally provided with the display unit 110. The display unit 110 is typically formed of a flat panel display, or may also be a liquid crystal display unit or an organic light emitting device. An operation of the display unit 110 is controlled by a control unit (not shown) included in the mobile device 100, and the control unit may control the display unit 110 to display a screen either in a horizontal mode or in a vertical mode according to necessity. Referring to FIG. 1, the display unit 110 generally provides a tetragonal screen 111 to a user, particularly, a rectangular screen in which a width and a length are not same. Hereinafter, the display unit 110 refers to a device displaying a screen itself, and the screen refers to any image such as a still image or a video image that is output on an effective display area of the display unit 110. That is, in general cases, the mobile device 100 outputs a screen on the effective display area of the display unit 110 according to executed applications.

### Magnification Function

In an embodiment, a magnification function of eyewear is able to differentiate between captured images that include a mobile device screen and image that do not include a mobile device screen. For those captured images that do not include a mobile device screen, the magnification function of the eyewear causes the image display device of the eyewear to display the captured image to the user at standard magnification (i.e., unmagnified). For those captured images that do include a mobile device screen, the magnification function of the eyewear causes the image display device of the eyewear to display the capture image to the user at an enhanced magnification, for example 1.5× magnification, 2.0× magnification, or any other suitable magnification that is greater than the standard magnification. The magnified image includes at least the mobile device screen. From an image processing standpoint, magnification may be performed in any suitable manner, such as by adjusting the lens array on the camera or digitally by mathematically processing pixels.

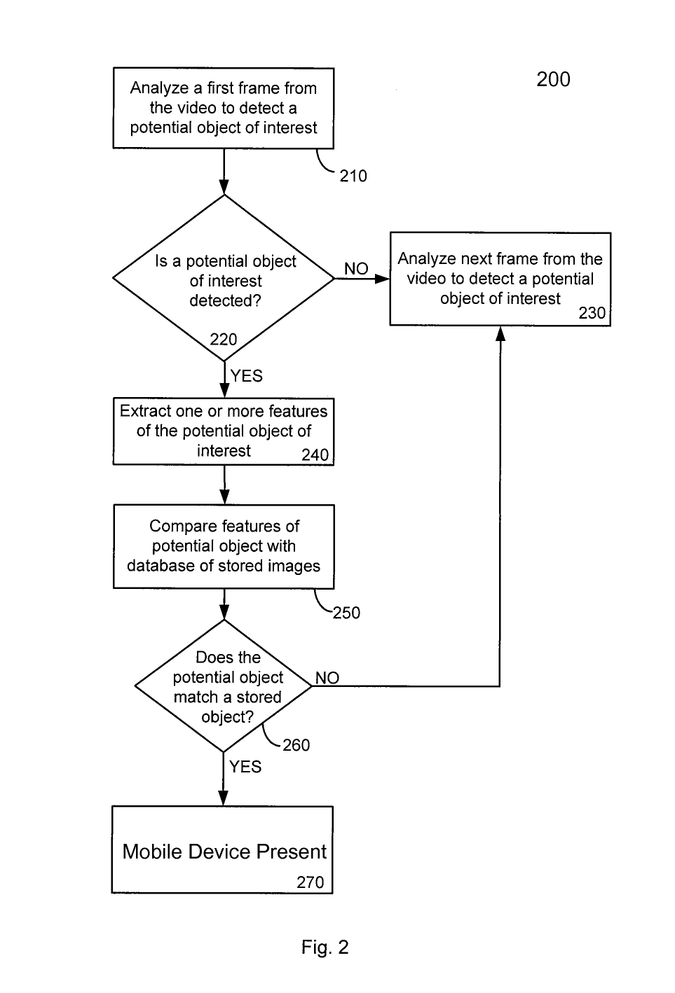

In this manner, the magnification function of the eyewear is able to differentiate between mobile device screens and other images, and one step of the exemplary method described herein includes determining whether a mobile device screen is present in the image captured by the eyewear. Image recognition may be performed according to various manners. For example, in one embodiment, FIG. 2 is a flowchart depicting a method 200 for detecting an image within the captured image that is captured by the eyewear. In accordance with the present disclosure, the image to be detected is the mobile device, the screen of the mobile device, or any other feature of the mobile device indicating that a mobile device is present in the field of view of the captured image.

Beginning in operation 210, the processor 144 may analyze an incoming image stream for an image contained there-within. More particularly, the processor 144 may extract a frame from the image stream capture by the eyewear, such as after the frame has been decoded and rendered. Once rendered, the processor 144 may scan the frame for an image that matches or approximates a related image stored in a searchable database stored within the eyewear and connected with the processor 144. More particularly and described in more detail below, the processor 144 may extract one or more features of an image within the frame and compare those features to stored features within a database to determine if the potentially matching image is contained within the frame of the video component of the presentation. The potentially matching image is referred to hereinafter as an “object of interest.” The object of interest may be the screen of a mobile device, the edge contours of a mobile device, or any other identifying characteristic of a mobile device that may be used to determine the presence of a mobile device in the extracted image frame.

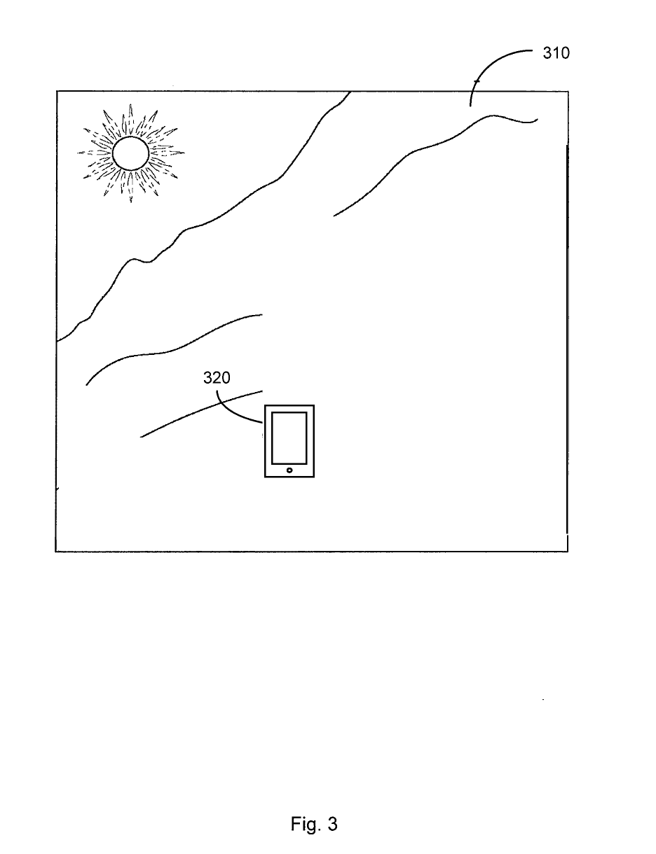

For example, FIG. 3 is a diagram of a capture image frame 310 that was capture by the eyewear in accordance with an embodiment, and including one or more images 320 that may be recognized by the methods and systems of the present disclosure. In particular, the frame 310 illustrated in FIG. 3 displays a landscape scenery including image 320 that represented a mobile device. This frame 310 may be any scenery encountered by the user when the user is wearing the eyewear. The frame 310 depicted in FIG. 3 is merely an example of a frame 310 of a video stream captured by the eyewear.

In general, any frame of the video component of the presentation may be analyzed to detect an object within the frame in operation 210. Object detection analysis of these frames may occur once the frames are rendered. In one example, the rendered frames of the video component may be stored in a memory device associated with the eyewear. In this example, object detection analysis of the frames may occur while the frames are stored in the memory device, prior to being displayed to the user through the eyewear.

In operation 220, the processor 144 may determine whether the frame of the video (such as frame 310 shown in FIG. 3) includes an object that may be of identified by the system and/or method of the present disclosure, i.e., an object associated with a mobile device. In general, the processor 144 may detect a potential object of interest by analyzing the frame 310 for certain markers or features of objects 320 within the frame. For example, the processor 144 may analyze the frame 310 of FIG. 3 to detect the screen, corners, etc. of the mobile device shown therein. More particularly, the processor 144 may be configured to scan the frame 310 for any number of features that may correspond to an object of interest.

The features of a potential object may be detected in several ways known to one of ordinary skill in the art. In one embodiment, the processor 144 may perform an analysis on the frame to determine a plurality of edges within the frame to detect a particular shape of an object. In general, edge detection may be accomplished by analyzing the pixels within the frame to detect abrupt color change from one or more pixels to a nearby group of one or more pixels. Through this analysis, the receiver may determine the edges of one or more objects within the frame, thereby detecting a general shape of an object within the frame. Further, as described in more detail below, this general shape may be compared with one or more stored shapes to determine an object displayed within the frame.

In another embodiment, the processor 144 may analyze several frames of the video to detect motion of an object across the display. In this embodiment, one or more points of the object may be detected by the processor 144 within several frames of the video. Thus, as the detected points move across the screen, the receiver may maintain information concerning the movement of the points. Further, the movement of the points may provide information to the receiver on the type of object that is moving through the several frames. This information may be compared with one or more stored images to determine the presence of the image in the frame. In one example, the detected points may correlate to similar points within the stored object, indicating the presence of the object within the captured frames.

In yet another embodiment, the database of objects may store three-dimensional (3-D) models of the objects of interest such that the receiver may detect the object regardless of the orientation of the object within the frame. In one embodiment, the stored 3-D model may include a fully rendered 3-D computer model. In other embodiments, the 3-D model may contain any number of 2-D images of the object at different angles. For example, the processor 144 may store an image of the object rotated 90 degrees to the right, 45 degrees to the right, perpendicular to the virtual camera, 45 degrees rotated to the left, etc. During detection, the processor 144 may first determine an orientation of a potential object through an analysis of the frame (such as by doing an edge analysis to determine the orientation of the mobile device). Once the potential orientation, or an approximation thereof, is obtained, the processor 144 may then compare the stored three-dimensional model corresponding to the potential orientation of the object to determine if the object is found within the frame. In another example, the objects within the frame may be compared to each of the stored rotated images to determine the presence of the object in the frame. In general, however, any method known to one of ordinary skill or in the art or hereafter developed to determine the presence of an object within a frame may be utilized in the present disclosure.

If the processor 144 determines in operation 220 that the frame does not include a feature of a potential object of interest, then the receiver may access a subsequent frame of the captured image stream and perform a similar analysis of the subsequent frame to detect the presence of such a feature. In one example, the additional frame may be the next rendered frame. However, because video is typically captured and displayed at several frames per second, the processor may bypass several frames in between accessing frames and analyzing them for an object of interest. In addition, the number of frames that are displayed between the analyzed frames may be at least partially based on the speed in which the processor 144 may perform the analysis on the frames for the objects. In general, however, once the receiver processor 144 that an potential object is not present in a captured frame, any subsequent frame of the image stream may be selected and analyzed to detect a mobile device object of interest within the additional frame in operation 230.

If the processor 144 determines that features of a potential mobile device object of interest is present in the capture frame in operation 220, then the processor 144 may extract or copy those features in operation 240 and compare the features with the objects stored in the database in operation 250. In general, the processor 144 may compare the features of the object to similar features of the stored objects in the database to find a correlation, or an approximate correlation between the features. If such a correlation or approximate correlation is found, then the video frame may include a mobile device object of interest.

In operation 260, the processor 144 may determine if the detected potential mobile device object of interest matches an object stored in the database based on the comparison performed in operation 250. If not, the processor 144 may discard the detected features and continue on to operation 230 to analyze a subsequent captured frame. However, if the detected features are verified in operation 260, then the processor may make the determination in operation 270 that a mobile device is present within the image field of the eyewear.

Based on the determination in operation 270, the magnification function of eyewear is able to differentiate between captured images that include a mobile device screen and image that do not include a mobile device screen. For those captured images that do not include a mobile device screen, the magnification function of the eyewear causes the image display device of the eyewear to display the captured image to the user at standard magnification (i.e., unmagnified). For those captured images that do include a mobile device screen, the magnification function of the eyewear causes the image display device of the eyewear to display the capture image to the user at an enhanced magnification, for example 1.5× magnification, 2.0× magnification, or any other suitable magnification that is greater than the standard magnification. Magnification may be performed in any suitable mariner, such as by adjusting the lens array on the camera or digitally by mathematically processing pixels. The processor 144 performs the magnification function such that at least the object of interest (i.e., the mobile device screen) is included in the magnified image.

### Method of Operation

In an exemplary method of operation 400 of the eyewear in accordance with the present disclosure for the purposes of magnifying mobile device screen images, in a first step 401, the user activates the eyewear. Activation typically includes the turning-on of electrical components and donning the eyewear on the user's head in the area of the user's eyes such that the user is able to see the display screens 130a, and the image capture devices 128 are generally oriented in the fore-view of the user. Once activated, the method 400 continues with a step 403 of capturing at least one image, and more often an image stream. In any event, the image (or a selected image of the image stream) is analyzed for the presence of an object of interest, namely a mobile device or an identifying portion of a mobile device, at step 405. The details of step 405 are provided in greater detail above in connection with FIGS. 2 and 3. The exemplary method 400 continues at step 407 wherein, if it is determined that no mobile device is present in the analyzed image, then the image displayed to the user through the eyewear's image display device is presented at standard magnification (presenting the image is described in greater detail below with regard to method step 411). Wherein, however, at step 409, if a mobile device is present, then the eyewear magnifies the image. That is, for those captured images that do include a mobile device screen, the magnification function of the eyewear causes the image display device of the eyewear to display the capture image to the user at an enhanced magnification, for example 1.5× magnification, 2.0× magnification, or any other suitable magnification that is greater than the standard magnification. Magnification may be performed in any suitable mariner, such as by adjusting the lens array on the camera or digitally by mathematically processing pixels. Magnification is performed such that the resulting magnified image includes at least the mobile device screen. Finally, at step 411, as discussed above with regard to the image display device 130 of the eyewear, the captured image, whether un-magnifying when no mobile device is determined to be present or magnified if a mobile device is indeed determined to be present, is displayed to the user. With the eyewear situated on the user's head, the image display device should be in proximity to the user's eyes for ease of viewing.

As the mobile device may move in and out of the user's field of view, the method 400 continues while the eyewear is operational. Thus, as the mobile device moves into the field of view, it is detected, and the image displayed to the user is magnified. When the mobile device subsequently moves out of view, it is no longer detected, and the magnification return to standard (un-magnified). Repeated instances of magnification, de-magnification, re-magnification, etc., are contemplated as the user wears the eyewear after a period of time. For example, method 400 may be performed again after a predetermined period of time has passed, for example 1 second, 10 second, 1 minute, etc., or any other desired predetermined period of time.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the embodiments in any way. Rather, the foregoing detailed description will provide those skilled in the art with a convenient road map for implementing an exemplary embodiment, it being understood that various changes may be made in the function and arrangement of elements described and methods of preparation in an exemplary embodiment without departing from the scope of the invention, which is set forth in the appended claims and their legal equivalents.

What is claimed is:

1. A system for magnifying the appearance of an image on a mobile device screen comprising:
an eyewear frame adapted to be mounted on a user in the user's field of vision;
an image capturing device connected to the eyewear frame and oriented to capture an image in the user's field of vision;
an image display device connected to the eyewear frame and oriented to display the captured image to the user; and
a processor in electronic connection with the image capturing device and the image display device, wherein the processor is configured to analyze the captured image for the presence of the mobile device screen in the user's field of vision, and, if the mobile device screen is present, magnify the captured image to include at least a magnified mobile device screen image in the magnified captured image and send the magnified captured image to the image display device for display to the user.

2. The system of claim 1, wherein the processor is further configured to send a standard, un-magnified captured image to the image display device if the mobile device screen is not present.

3. The system of claim 1, wherein the eyewear frame is configured in the manner of an eyeglasses frame.

4. The system of claim 3, wherein the eyewear frame comprises connected thereto two image capturing devices, one positioned with respect to each eye of the user.

5. The system of claim 4, wherein the eyewear frame comprises connected thereto two image display devices, one positioned with respect to each eye of the user.

6. The system of claim 5, wherein the eyewear frame further comprises connected thereto an eye tracking camera for tracking a movement of at least one of the user's eyes.

7. The system of claim 1, wherein the processor is configured to adjust a lens array on the image capturing device to magnify the captured image.

8. The system of claim 1, wherein the processor is configured to digitally and mathematically process pixels of the captured image to magnify the captured image.

9. The system of claim 1, wherein the processor is configured to magnify the captured image at least 1.5×.

10. The system of claim 9, wherein the processor is configured to magnify the captured image at least 2.0×.

11. The system of claim 1, wherein the processor communicates with the image capturing device and the image display device using a wired connection.

12. The system of claim 1, wherein the processor communicates with the image capturing device and the image display device using a wireless connection.

13. A method for magnifying the appearance of an image on a mobile device screen comprising the steps of:
capturing an image;
analyzing the image for the presence of a mobile device and determining if a mobile device is present in the image based on the analyzing;
if a mobile device is determined to be present in the image:
magnifying the captured image to include at least a magnified mobile device screen image in the magnified captured image; and
displaying the magnified captured image.

14. The method of claim 13, wherein if a mobile device is determined not to be present in the image:
displaying the captured image.

15. The method of claim 13, further comprising capturing a movement of a user's eye.

16. The method of claim 13, wherein magnifying comprises magnifying to a factor of at least 1.5×.

17. The method of claim 16, wherein magnifying comprises magnifying to a factor of at least 2.0×.

18. The method of claim 13, wherein capturing the image comprises capturing at least two images for a stereoscopic captured image.

19. The method of claim 18, wherein displaying the magnified captured image comprises displaying a stereoscopic magnified captured image.

20. The method of claim 13, further comprising, after a period of time, determining that the mobile device is no longer present in the image and de-magnifying the magnified captured image.
